(19) United States
(12) Patent Application Publication
(10) Pub. No.: US 2012/0133334 A1
(43) Pub. Date: May 31, 2012

(54) METHOD AND CHARGING APPARATUS FOR CHARGING A MOTOR VEHICLE BATTERY

(75) Inventors: Walter Lachenmeier, Sankt Augustin (DE); Andreas Gutsch, Luedinghausen (DE); Tim Schaefer, Niedersachswerfen (DE)

(73) Assignee: LI-TEC BATTERY GMBH, Kamenz (DE)

(21) Appl. No.: 13/202,841

(22) PCT Filed: Dec. 4, 2009
(86) PCT No.: PCT/EP2009/008686

§ 371 Date: Feb. 15, 2012

(30) Foreign Application Priority Data
Feb. 23, 2009 (DE) 10 2009 010 144.6

(51) Int. Cl. H02J 7/00

(52) U.S. Cl. 320/137; 180/65.21; 903/903

(57) ABSTRACT

The invention relates to a method for charging at least one motor vehicle battery (3) during the operation of the motor vehicle (1). According to the invention, the charging current for the motor vehicle battery (3) is obtained at least partially by converting mechanical power on the vehicle suspension (5a, 5b). The invention further relates to a charging apparatus for a motor vehicle battery (3) and to a motor vehicle (1) comprising such a charging apparatus.

Priority application DE 10 2009 010 144.6 is fully incorporated by reference into the present application.

The invention relates to a method for charging a motor vehicle battery during the operating of the motor vehicle, and a charging apparatus and a motor vehicle comprising such a charging apparatus.

The operation of a motor vehicle always entails losses in all kinds of types. This is to be understood to mean that an energy which is potentially available for the operation of the motor vehicle, such as e.g. the electrical energy of a battery or the latent energy of a fuel, can only be used conditionally for the operation of the motor vehicle. Numerous approaches are known from the prior art, in order to improve the energy efficiency in the operation of a motor vehicle, by e.g. taking measures to increase the efficiency in energy conversion.

It is the object of the invention to further improve the energy efficiency in operation of a motor vehicle.

This problem is solved by a method having the features of Claim 1. The object id further solved by a charging apparatus and by a motor vehicle according to the independent claims. Advantageous and preferred further developments are the subject matter of the respectively dependent claims.

According to the invention, a method is proposed for charging or respectively electrically feeding at least one motor vehicle battery during the operation of the motor vehicle, in which the charging current for the motor vehicle battery is obtained at least partially by converting mechanical power on the vehicle suspension.

A motor vehicle battery is a component which stores electrical energy and emits is again, for example for starting an internal combustion engine and/or for operating an electric motor. According to its function, such a battery can also be designated as an accumulator. Motor vehicle batteries are available on the market for various purposes of use and in various specifications, in particular as finished prepared components. According to the invention, a plurality of motor vehicle batteries can also be provided, which are electrically charged simultaneously or according to an established hierarchy.

The vehicle suspension is part of the chassis of a motor vehicle. It is intended to ensure that the wheels of the motor vehicle follow any unevenness in the road surface, whereas on the other hand the body of the motor vehicle remains largely unaffected by this. The vehicle suspension therefore serves on the one hand for travelling comfort, but also on the other hand for travelling safety, by ensuring contact by the wheels with the road surface. A vehicle suspension mostly comprises several spring-damper combinations, which are also designated as shock absorbers, and which decouple the wheels of the motor vehicle from the body of the motor vehicle with regard to vibrations.

Modern calculation methods show that the power loss on the vehicle suspension for a medium-class passenger car, which travels at 100 km/h on a substantially flat concrete road surface, amounts to a total of approximately 4 kW and above. The invention is based on the idea of recovering this power loss through conversion into electrical energy or respectively into electrical power and of using this for charging the motor vehicle battery. This is brought about by the method according to the invention. Thereby, the energy efficiency during the operation of a motor vehicle can be improved, whereby the energy consumption of the motor vehicle and the associated damage to the environment are reduced. The invention is suitable equally for passenger cars and for heavy goods vehicles. In addition, the invention is also suitable for the refitting of older motor vehicles.

According to a preferred further development, provision is made that the mechanical power on the vehicle suspension is a spring power on at least one shock absorber of the motor vehicle, which is converted at least partially into electric power and is used as charging current for the motor vehicle battery.

As already explained above, a shock absorber is a spring-damper combination. The spring is intended to absorb road surface shocks and convert them into vibrations. The damper is intended to damp these vibrations in the shortest possible time. According to the prior art, a portion of the spring power here (product of force and spring deflection) is converted into heat, which is emitted unused into the environment. By comparison, it is proposed according to the invention to at least partially generate a charging current from this spring power and to use this for charging the vehicle battery. Accordingly, the shock absorber functions as a generator. The tapping of the generated electrical power at the shock absorber increases, in addition, its damping effect. By technical measures related to circuitry and/or control, in addition also an asymptotic damping of the shock absorber can be promoted.

According to a preferred further development, provision is made that the conversion on a shock absorber is based on an inductive principle and/or on a piezo principle. The inductive principle can be implemented in particular by a coil-magnet combination, in which by relative movement of coil and magnet a usable electrical voltage is induced. The piezo principle can be implemented for example by the use of commercially available piezo components. Alternatively and/or in addition, an electrochemical conversion principle is also conceivable.

According to a preferred further development, provision is made that the conversion at least of a portion of the mechanical spring power into electrical power takes place both with a positive spring deflection and also with a negative spring deflection on the shock absorber. A positive spring deflection exists on wheel spring compression in the direction of the body of the motor vehicle, a negative spring deflection exists on the opposite wheel spring extension. In particular, provision is made that the conversion takes place at least on spring compression.

According to the invention, in addition a charging apparatus is proposed for at least one motor vehicle battery, wherein this charging apparatus comprises at least one converter which converts mechanical power on the vehicle suspension at least partially into electrical power and provides this as charging current for the motor vehicle battery. This charging apparatus is suited or respectively arranged in particular for operation by the method according to the invention. At this point, reference is to be made to the above statements regarding the method according to the invention, which correspondingly also apply to the charging apparatus according to the invention.

According to a preferred further development, provision is made that the converter is integrated into a shock absorber of the vehicle suspension. The term “integrated” is to be interpreted broadly here and comprises any force-coupled arrangement of shock absorber and converter.

According to a preferred further development, provision is made that the converter is formed from a coil-magnet combination. A magnet is in particular a permanent magnet. On the other hand, a magnet can also be an electromagnet. This is explained in further detail below in connection with the figures.

According to a preferred further development, provision is made that a shock absorber comprises at least one linear motor, which can be operated as a generator. A linear motor in the sense of the invention is an electromechanical converter which can convert an electrical value, such as in particular a current, into a mechanical rectilinear motion (translatory motion) and/or vice versa. Preferably, this linear motor can also be operated as a servomotor, whereby the damping behaviour of the shock absorber and hence the springing behaviour of the vehicle suspension can be adapted for example as required by the situation.

According to a preferred further development, provision is made that a control unit is comprised for controlling the charging current. The control unit makes possible inter alia an alignment, a linearization and/or a limitation of the charging current, and a monitoring of the charging process of a motor vehicle battery in real time. The control unit preferably also makes possible a regulation of the damping behaviour at least of one shock absorber. In particular, the shock absorber comprises for this a linear motor which is able to be operated as a servomotor, as previously explained, which is controlled by the control unit.

According to a preferred further development, provision is made that the motor vehicle battery which is to be charged is a lithium-ion battery. The combination with such a lithium-ion battery has proved to be particularly advantageous, because this makes dynamic charging and discharging processes possible.

According to the invention, in addition a motor vehicle is proposed, comprising a charging apparatus according to the invention.

According to a preferred further development, provision is made that this motor vehicle comprises an electric drive or a hybrid drive, which is supplied with energy at least partially from the motor vehicle battery which is to be charged.

Further advantages, features and possibilities for application of the present invention will become apparent from the following description, by way of example, in connection with the figures, in which are shown:

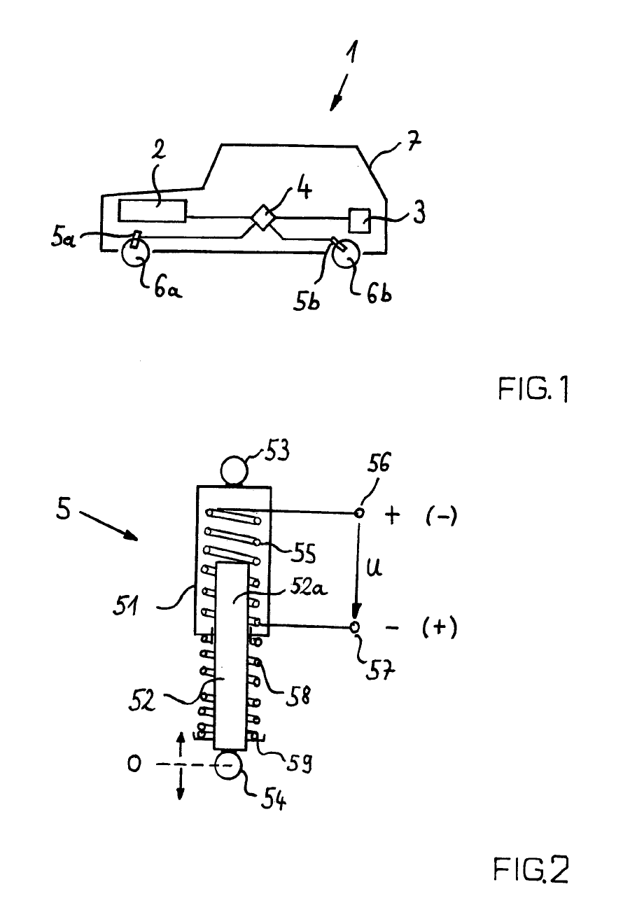

FIG. 1 a motor vehicle according to the invention, in a diagrammatic view,

FIG. 2 a diagrammatic sectional view of a shock absorber of the motor vehicle of FIG. 1.

FIG. 1 shows a motor vehicle 1. The latter comprises a drive motor 2, which can be embodied as an internal combustion engine or as an electric motor. Instead of the drive motor 2, a hybrid drive may also be provided. The motor vehicle 2 further comprises a motor vehicle battery 3, which stores electrical energy and emits this again, for example for starting or for operating the drive motor 2. Instead of a single motor vehicle battery 3, a plurality of motor vehicle batteries can also be comprised. The motor vehicle battery 3 is preferably embodied as a lithium-ion battery. In addition, a control unit 4 is comprised, which controls the charging of the motor vehicle battery and its discharging, i.e. the power output. The wheels 6a and 6b are connected with the body 7 of the motor vehicle via shock absorbers 5a and 5b of a vehicle suspension.

The charging current for charging the motor vehicle battery 3 is obtained according to the invention at least partially by the conversion of mechanical power on the vehicle suspension. For this, the shock absorbers 5a and 5b are equipped with a converter, which converts the spring power or respectively spring energy at least partially into electrical power or respectively electrical energy, which is used as charging current for charging the motor vehicle battery 3. The charging current and hence the charging of the vehicle battery 3 is controlled by the control unit 4.

FIG. 2 shows the structure of a shock absorber 5 in a diagrammatic sectional view. The latter comprises a spring strut 52 which is mounted telescopically in a support 51. A helical spring 58, which rests against a spring plate 59 and against the support 51, is arranged coaxially to the spring strut 52. The spring 58 is intended to absorb road surface shocks and convert them into vibrations, and to ensure contact with the road surface by the connected wheel 6a or respectively 6b. For connection with the wheel 6a or respectively 6b and with the body 7, the shock absorber 5 has fastening arrangements 53 and 54, which are constructed here by way of example as eyes.

The spring strut 52 has a structurally established zero position 0 with respect to the support 51, said position being able to be indicated by the position of the lower fastening device 54. Hereby, the zero position of a wheel 6a or respectively 6b to the body 7 is also defined.

Proceeding from this zero position 0, the spring strut 52 can make a positive spring deflection, i.e. deflect upwards into the support 51 in accordance with the illustration, and can made a negative spring deflection, i.e. rebound downwards in accordance with the illustration.

With a movement of the spring strut 52, its end 52a situated in the support 51 moves within an electric coil 55 arranged in the support 51. The coil 55 is illustrated here as a single-layer winding, but may also be configured having multiple layers. The end 52a of the spring strut 52 has a permanent magnet arrangement, whereby an electrical voltage U is induced in the coil 55 in accordance with the physical laws of induction, said voltage being able to be tapped between the contacts 56 and 57. The prefix of the electrical voltage U is dependent on the present direction of motion of the spring strut 52 relative to the support 51. In this way, taking into account an efficiency, a mechanical spring power can be converted into electrical power, which is used as charging current for the vehicle battery 3.

The electrical power tapped between the connections 56 and 57 influences at the same time the damping behaviour of the shock absorber 5, so that via the removal of electrical power, the springing behaviour of the vehicle suspension can be altered or respectively adjusted and therefore adapted as required by the situation. This is likewise controlled via the control arrangement 4. In addition, the shock absorber 5 can be provided with further damping elements, such as e.g. an oil pressure or gas pressure damper.

Instead of a permanent magnet arrangement at the end 52a of the spring strut 52, a controllable electromagnet can also be used. Deviating from the embodiment of a shock absorber 5 which is shown, the coil 55 can also be arranged at the end 52a of the spring strut 52 and a permanent magnet arrangement and/or electromagnet arrangement can be arranged on the support 51.

Instead of the coil-magnet combination which is shown, a linear motor can also be integrated into the shock absorber 5, which can optionally be operated as a generator or as a servomotor. Hereby, the damping behaviour of the shock absorber can be actively altered, which is controlled by the control unit 4 as required by the situation.

Instead of the telescopic shock absorber 5 with the helical spring 58 which is shown, other types of shock absorber can also be used, which comprise e.g. a plate spring or a torsion bar spring. The converter for converting the mechanical spring power into electric power is then to be adapted accordingly to the respective type of shock absorber. Thus, e.g. instead of the longitudinally movable converter described above, rotationally movable converters can also be used.

1.-12. (canceled)

13. A method for charging at least one motor vehicle battery (3) during the operation of the motor vehicle (1), in which the charging current for the motor vehicle battery (3) is obtained at least partially by converting mechanical power on the vehicle suspension and the mechanical power is a spring power on at least one shock absorber (5) of the motor vehicle (1),
wherein
a control unit (4) for controlling the charging current makes possible a regulation of the damping behaviour at least of one shock absorber (5), and that the shock absorber (5) comprises at least one linear motor, which is operated as a generator and as a servomotor.

14. The method according to claim 13,
wherein
the conversion is based on an inductive principle or on a piezo principle.

15. The method according to claim 14,
wherein
the conversion takes place both on a positive spring deflection and also on a negative spring deflection.

16. A charging apparatus for at least one motor vehicle battery (3), which is suited for operation by the method according to claim 13, which comprises at least one converter, which converts mechanical power on the vehicle suspension at least partially into electrical power and provides this as charging current for the motor vehicle battery (3), wherein the converter is integrated in a shock absorber (5) of the vehicle suspension,
wherein
it comprises a control unit (4) for controlling the charging current, which makes possible a regulation of the damping behavior at least one of one shock absorber (5), and that the shock absorber (5) comprises at least one linear motor, which is able to be operated as a generator and as a servomotor.

17. The charging apparatus according to claim 16,
wherein
the converter is formed from a coil-magnet combination.

18. The charging apparatus according to claim 17,
wherein
the motor vehicle battery (3) which is to be charged is a lithium-ion battery.

19. A motor vehicle (1) comprising the charging apparatus according to claim 18.

20. The motor vehicle (1) according to claim 19,
wherein
the motor vehicle comprises an electric drive or a hybrid drive, which is supplied with energy at least partially by the motor vehicle battery (3) which is to be charged.
